(19) United States
(12) Patent Application Publication
(10) Pub. No.: US 2007/0110997 A1
(43) Pub. Date: May 17, 2007

(54) Polymeric film structures and compositions for high surface treatment retention

(75) Inventor: Juan J. Aguirre, League City, TX (US)

Correspondence Address: FINA TECHNOLOGY INC, PO BOX 674412, HOUSTON, TX, 77267-4412, US

(73) Assignee: Fina Technology, Inc.

(21) Appl. No.: 11/281,129

(22) Filed: Nov. 17, 2005

(51) Int. Cl. B32B 27/32; B32B 15/04

(52) U.S. Cl. 428/349; 428/523; 428/457; 428/910

(57) ABSTRACT

A multilayer polymer film having at least one core layer disposed between an outer skin layer and an inner skin layer wherein the outer skin layer is surface treated and comprises a polymer of ethylene having a density of at least 0.95 g/cc, a molecular weight distribution of less than about 7.0 and a Carreau-Yasuda “a” parameter value of greater than about 0.25. A multilayer polymer film having at least one core layer disposed between a high density polyethylene outer skin layer and an inner skin layer wherein the outer skin layer is surface treated and retains an increased surface tension on the surface treated skin layer for greater than about 30 days in comparison to the surface tension of an otherwise identical film having an untreated outer skin layer. A surface treated, outer skin layer of a multilayer polymer film, wherein the outer skin layer comprises high density polyethylene and retains an increased surface tension on the surface treated skin layer for greater than about 30 days in comparison to the surface tension of an otherwise identical film having an untreated outer skin layer.

### CROSS-REFERENCE TO RELATED APPLICATIONS

Not applicable.

### STATEMENT REGARDING FEDERALLY SPONSORED RESEARCH OR DEVELOPMENT

Not applicable.

### BACKGROUND OF THE INVENTION

1. Field of the Invention

This disclosure relates to polymer compositions and multilayer polymer film structures. More specifically, this disclosure relates to multilayer polymer film structures exhibiting high surface treatment retention.

2. Background of the Invention

Synthetic polymeric materials, particularly plastic resins, are manufactured into a variety of end-use articles ranging from medical devices to food containers. Generally, plastics such as polypropylene and polyethylene have chemically inert surfaces with low surface tensions. This low surface tension results in the plastic surface being resistant to bonding with substrates, printing, coating and other adhesives. In order to improve the bonding characteristics of the plastic surfaces, surface modification is often necessary.

The most common method of surface modification to improve the bonding characteristics of a plastic surface is corona treatment. Corona treatment is an electrical process that uses ionized air to increase the surface tension of nonporous substrates. A plastic surface subjected to corona treatment may have a higher surface tension due to the elimination of weak boundary layers, increased surface roughness due to pitting, the introduction of polar groups, and other chemical changes on the surface. A major drawback of corona treatment is the that the treatment degrades with time requiring in some cases repeated treatments or higher levels of initial treatment in an effort to maintain the increased surface tension. The need to retreat the plastic surface can present health, safety and environment (HSE) concerns due to the generation of potentially hazardous chemicals during surface modification processes such as corona treatment. In the case of corona treatment, it has been found that the majority of treatment loss occurs when the treated plastic surface contacts an untreated surface as in the case of the production of multilayer polymer film structures. Thus an ongoing need exists for a polymer film structure with an enhanced ability to retain surface tension after a surface modification process.

### BRIEF SUMMARY OF SOME OF THE PREFERRED EMBODIMENTS

Disclosed herein is a multilayer polymer film having at least one core layer disposed between an outer skin layer and an inner skin layer wherein the outer skin layer is surface treated and comprises a polymer of ethylene having a density of at least 0.95 g/cc, a molecular weight distribution of less than about 7.0 and a Carreau-Yasuda “a” parameter value of greater than about 0.25.

Further disclosed herein is a multilayer polymer film having at least one core layer disposed between a high density polyethylene outer skin layer and an inner skin layer wherein the outer skin layer is surface treated and retains an increased surface tension on the surface treated skin layer for greater than about 30 days in comparison to the surface tension of an otherwise identical film having an untreated outer skin layer.

Further disclosed herein is a surface treated, outer skin layer of a multilayer polymer film, wherein the outer skin layer comprises high density polyethylene and retains an increased surface tension on the surface treated skin layer for greater than about 30 days in comparison to the surface tension of an otherwise identical film having an untreated outer skin layer.

The foregoing has outlined rather broadly the features and technical advantages of the present invention in order that the detailed description of the invention that follows may be better understood. Additional features and advantages of the invention will be described hereinafter that form the subject of the claims of the invention. It should be appreciated by those skilled in the art that the conception and the specific embodiments disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims.

### BRIEF DESCRIPTION OF THE DRAWINGS

For a detailed description of the preferred embodiments of the invention, reference will now be made to the accompanying drawings in which:

FIG. 1 is a diagram of a multilayer polymer film.

FIG. 2 is a graph of treatment as a function of time.

### DETAILED DESCRIPTION OF THE PREFERRED EMBODIMENTS

Disclosed herein are multilayer polymer film (MPF) structures and methods of making same. The MPFs of this disclosure have an outer skin layer comprising a polymer of ethylene (PE), an inner skin layer and at least one core layer. Such MPFs may display an enhanced retention of surface treatments designed to increase their surface bonding characteristics.

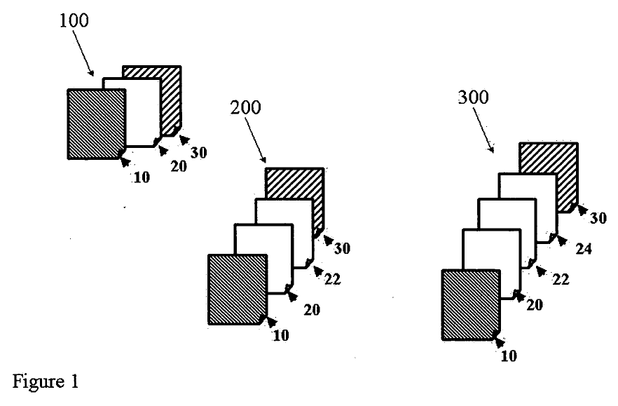

In an embodiment shown in FIG. 1, a MPF 100, comprises a core layer 20, disposed between an outer skin layer 10 and an inner skin layer 30. In another embodiment also shown in FIG. 1, a MPF 200, comprises two core layers 20 and 22 disposed between an outer skin layer 10 and an inner skin layer 30. Referring again to FIG. 1, in yet another embodiment, a MPF 300, comprises three core layers 20, 22 and 24 disposed between an outer skin layer 10 and inner skin layer 30. Alternatively, a MPF contains n core layers, where n≧1, disposed between an outer skin layer and an inner skin layer. Such core layers may be the same or different as will be described in more detail herein. In packaging embodiments, the outer skin layer refers to the outside surface of the packaging that may be printed and the inner skin layer refers to the inner surface of the packaging that is in contact with the packaged good, for example a food item. The inner skin layer may further function as a sealing layer.

In an embodiment, the outer skin layer of a MPF comprises a polymer of ethylene (PE), for example a high-density polyethylene (HDPE). The HDPE may be a homopolymer or a copolymer, for example a copolymer of ethylene with one or more alpha-olefin monomers such as propylene, butene, hexene, etc. In an embodiment, the HDPE is a homopolymer. The HDPE may have a molecular weight distribution (MWD) of less than about 7.0, alternatively less than about 6.5, alternatively less than about 6.0. The HDPE may be further characterized by a density of greater than about 0.950 g/cc, alternatively greater than about 0.960 g/cc. The HDPE may have a haze of from about 1.0% to about 15.0%.

In an embodiment, a HDPE suitable for use in this disclosure is characterized as having a rheological breadth greater than conventional HDPE resins. Rheological breadth refers to the breadth of the transition region between Newtonian and power-law type shear rate or frequency dependence of the viscosity. The rheological breadth is a function of the relaxation time distribution of the resin, which in turn, is a function of the resin molecular structure or architecture. Assuming Cox-Merz rule, rheological breadth may be calculated by fitting flow curves generated in linear-viscoelastic dynamic oscillatory frequency sweep experiments with a modified Carreau-Yasuda (CY) model, represented as follows:

$$η = {{η}_{o} [ 1 + {( λ \dot{γ} )}^{a} ]}^{\frac{n - 1}{a}}$$

where
η=viscosity (Pa s)
\dot{γ}=shear rate (1/s)
a=rheological breadth [describes the breadth of the transition region between Newtonian and power law behavior]
λ=relaxation time sec [describes the location in time of the transition region]
η₀=zero shear viscosity (Pa s) [defines the Newtonian plateau]
n=power law constant [defines the final slope of the high shear rate region]

The HDPE may have a rheological breadth parameter “a” of greater than about 0.25, alternatively greater than about 0.3.

Examples of HDPEs suitable for use in this disclosure include without limitation 6450 HDPE which is a polyethylene resin and mPE ER 2283 POLYETHYLENE which is a metallocene high density polyethylene resin with hexene as comonomer, both are commercially available from Total Petrochemicals USA, Inc. In an embodiment, a suitable HDPE has about the physical properties set forth in Table 1A (e.g., 6450 HDEP) or Table 1B (e.g., ER 2283).

TABLE 1A

| Properties | Typical Value | ASTM Method |
|---|---|---|
| Resin Properties⁽¹⁾ | | |
| Melt Flow Index, g/10 min | | D 1238 |
| 190° C./2.16 kg | 5.0 | |
| Density, g/cm³ | 0.962 | D 792 |
| Melting Point, ° F. | 265 | D 3417 |
| Film Properties⁽¹⁾⁽²⁾ | | |
| Haze, % | 5.0 | D 1003 |
| Gloss, % | 85 | D 523 |
| Tensile Strength @ Break, psi | | D 882 |
| MD | 3500 | |
| TD | 3800 | |
| Elongation @ Break, % | | D 882 |
| MD | 850 | |
| TD | 650 | |
| Secant Modulus @ 2% Strain, psi | | D 882 |
| MD | 100,000 | |
| TD | 130,000 | |
| WVTR⁽³⁾ @ 100° F., g/100 in²/day | 0.5 | E 96/66 |
| Low Temp. Brittleness, ° F. | <−112 | D 746 |

⁽¹⁾Data developed under laboratory conditions and are not to be used as specification, maxima or minima.
⁽²⁾The data listed were determined on 1.0 mil cast film.
⁽³⁾Water Vapor Transmission Rate.

TABLE 1B

| Properties | Method | Unit | Value |
|---|---|---|---|
| Physical Properties | | | |
| Density | ISO 1183 | g/cm³ | 0.950 |
| Melt Index (2.16 kg) | ISO 1133 | g/10 min | 2.0 |
| Melting Point | EN ISO 11357 | ° C. | 133 |
| Vicat Temperature | ISO 306 | ° C. | 130 |
| Cast Film Properties | | | |
| Dart Impact | ISO 7765-1 | g | 36 |
| Tensile Strength at Yield MD/TD | ISO 527-3 | MPa | 23/24 |
| Tensile Strength at Break MD/TD | ISO 527-3 | MPa | 43/41 |
| Elongation at Break MD/TD | ISO 527-3 | % | 640/820 |
| Elmendorf MD/TD | ISO 6393 | N/mm | 8/130 |
| Haze | ISO 14782 | % | 10 |
| Gloss 45° | ASTM D 2457 | | 68 |

HDPE may be prepared by any means known to one skilled in the art. For example, the reaction may take place in a loop reactor where ethylene and an α-olefin comonomer (if used) circulate in a liquid phase. The catalyst and an inert solvent are introduced into the loop reactor, which is maintained at a temperature below the melting point of HDPE (about 135° C.) to ensure the polymer is formed in the solid state. The ethylene, α-olefin comonomer (if used), catalyst, and inert solvent are continuously charged into the reactor at a total pressure of, e.g., 450 psig. The slurry containing the polymer may be continuously removed from the reactor. The molecular weight of the HDPE can be controlled by the temperature of the catalyst preparation, the temperature of the reactor, and by the addition of hydrogen into the reactor.

Another type of process used to create HDPE is gas-phase polymerization. In this process, ethylene and an α-olefin comonomer (if used) is reacted with an active catalyst to form HDPE. Likewise, the molecular weight of the HDPE can be controlled by the temperature of the catalyst preparation, the temperature of the reactor and by the addition of hydrogen into the reactor.

Any catalyst known in the art for the polymerization of ethylene, such as a metallocene catalyst or a Ziegler-Natta catalyst may be used in the preparation of the HDPE. In an embodiment, the HDPE is produced using a metallocene catalyst may be denoted as mHDPE. Examples of suitable Ziegler-Natta catalysts include without limitation those disclosed in U.S. Pat. No. 6,174,971 and in the following patent applications: U.S. patent application Ser. Nos. 09/687,378, 09/687,688 and 09/687,560, each of which is incorporated herein by reference in its entirety. Methods, catalysts and conditions for the preparation of a suitable HDPE are also disclosed in U.S. Published Application 2003/0030174, which is incorporated by reference herein in its entirety.

In an embodiment, the inner skin layer of a MPF comprises a copolymer or a terpolymer. The copolymer or terpolymer may be ethylene-based, which may be formed by the catalyzed polymerization of primarily ethylene with lesser amounts of second and third monomers, typically alpha-olefins such as propylene or butene. Alternatively, the copolymer or terpolymer may be propylene-based, which may be formed by the catalyzed polymerization of primarily propylene with lesser amounts of second and third monomers, typically alpha-olefins such as ethylene or butene. In an embodiment, the inner skin layer is a propylene-based terpolymer. An example of suitable propylene-based terpolymer includes without limitation ADSYL 5C30F advanced polyolefin that is an ethylene-propylene-butene-1 random terpolymer commercially available from Basell Polyolefins. In an embodiment, the terpolymer (e.g. ADSYL 5C30F) has about the physical properties set forth in Table 2.

TABLE 2

| Typical Properties | Value Unit | Method |
|---|---|---|
| Physical | | |
| Density—Specific Gravity | 0.902 sp gr | ASTM D 792 |
| | 23/23° C. | |
| Melt flow rate (230° C./2.16 kg) | 5.50 g/10 min | ASTM D 1238 |
| Mechanical | | |
| Tensile Strength @ Yield | 21.4 MPa | ASTM D 638 |
| Flexural Modulus (1 mm/min, | 648 MPa | ASTM D 790 |
| 1% Secant, Procedure A) | | |
| Tensile Elongation @ Yld | 13% | ASTM D 638 |
| Impact | | |
| Notched izod impact (23° C., | 85.4 J/m | ASTM D 256 |
| Method A) | | |
| Thermal | | |
| DTUL @ 66 psi—Unannealed | 62.8° C. | ASTM D 648 |
| Seal Initiation Temperature | 105° C. | |
| Melting Tempeature | 132° C. | |
| Vicat Softening Tempearture A/50 | 107° C. | ISO 306 |

Methods and conditions for their production of a propylene or ethylene-based terpolymers are known to one of ordinary skill in the art and are described in U.S. Pat. No. 6,562,478, which is incorporated herein by reference in its entirety.

In an alternative embodiment, the inner skin layer of a MPF comprises a random copolymer (RCP). The RCP may be for example a copolymer of propylene with one or more alpha-olefin monomers such as ethylene, butene, hexene, etc., referred to as a random copolymer of polypropylene (rcPP). Alternatively, the RCP may be a metallocene-catalyzed propylene random copolymer. The rcPP may have a melting point range of from about 115° C. to about 140 ° C.; alternatively from about 120° C. to about 134° C. The melting point range is indicative of the degree of crystallinity of the polymer.

Without limitation, examples of a suitable rcPP include POLYPROPYLENE 8573 random copolymer and POLYPROPYLENE EOD01-03 metallocene film resin, which are commercially available from Total Petrochemicals USA, Inc. In an embodiment, the rcPP has about the physical properties set forth in Table 3A (e.g. PP 8573) or Table 3B (e.g., EOD01-03).

TABLE 3A

| Properties | Typical Value | ASTM Method |
|---|---|---|
| Resin Properties⁽¹⁾ | | |
| Melt Flow, g/10 min. | 6.28 | D 1238 |
| | | 250° C./2160 g |
| Density, g/cc | 0.895 | D 1505 |
| Melting Point, ° F. (° C.) | 275 (135) | DSC⁽²⁾ |
| Film Properties, Non-Oriented⁽¹⁾ | | |
| Haze, % | 2 | D 1003 |
| Gloss, 45°, % | 85 | D 2457 |
| Ultimate Tensile, psi (MPa) | 3,000 (21) | D 882 |
| 1% Secant Modulus, psi (MPa) | 70,000 (483) | D 882 |
| Elongation at Break, % | 500 | D 882 |
| MVTR, g/100 sg. in./24 hrs | 0.9 | E 96 |
| @ 100 ° F., 90% RH | | |
| Dart Impact (F50), g/mil | 240 | D 1709 |
| Heat Seal Temperature, ° F. (° C.) | 244 (118) | (3) |
| | | D 785A |
| Thermal Properties⁽¹⁾ | | |
| Heat Deflection | | D 648 |
| ° F. at 66 psi | 185 | |
| ° C. at 4.64 kg/cm² | 85 | |

⁽¹⁾Data developed under laboratory conditions and are not to be used as specification, maxima or minima.
⁽²⁾MP determined with a DSC-2 Differential Scanning Calorimeter.
⁽³⁾Minimum Seal Strength is 200 g/min at 15 psi pressure and 1 sec.

TABLE 3B

| Properties | Typical Value | ASTM |
|---|---|---|
| Resin Properties⁽¹⁾ | | |
| Melt Flow, g/10 min. | 8 | D 1238 |
| Density, g/cc | 0.9 | D 1505 |
| Melt Point, ° F. (° C.) | 273 (134) | DSC⁽²⁾ |
| Film Properties⁽¹⁾ Non-Oriented—2 mil | | |
| (50 μm) | | |
| Haze, % | 0.4 | D 1003 |
| Gloss @ 45° , % | 90 | D 2457 |
| 1% Secant Modulus, psi (MPa) | 70,000 (480) | D 882 |
| Ultimate Tensile Strength, psi (MPa) | 7,800 (54) | D 882 |
| Ultimate Elongation, % | 800 | D 882 |
| WVTR, g/100 in²/day/mil (g/m²/day/25 mm) | 0.90 (14) | F 1249-90 |
| OTR, cc/100 in²/day/mil (cc/m²/day/25 mm) | 340 (5,300) | D 3985-95 |
| Heat Seal Temperaturet⁽³⁾, 0° F. (° C.) | 243 (117) | |

⁽¹⁾Data developed under laboratory conditions and are not to be used as specification, maxima or minima.
⁽²⁾MP determined with a Differential Scanning Calorimeter.
⁽³⁾Seal condition: die pressure 60 psi (413 kPa), dwell time 1.0 sec.

rcPPs may be prepared through the use of conventional Ziegler-Natta catalysts of the type disclosed, for example in U.S. Pat. Nos. 4,298,718 and 4,544,717, each of which is incorporated herein by reference in its entirety. rcPPs may also be prepared through the use of metallocene catalysts of the type disclosed and described in further detail in U.S. Pat. Nos. 5,158,920, 5,416,228, 5,789,502, 5,807,800, 5,968,864, 6,225,251, and 6,432,860, each of which is incorporated herein by reference in its entirety. Standard equipment and procedures for polymerizing propylene and ethylene into a random copolymer are known to one skilled in the art.

In an embodiment, the core layer of a MPF comprises a polymer of propylene (PP). The PP may be a copolymer, for example a copolymer of propylene with one or more alpha-olefin monomers such as ethylene, butene, hexene, etc. In an embodiment, the PP is a random ethylene-propylene (C₂/C₃) copolymer, alternatively, a mini-random copolymer (mini-RCP). As used herein, the term mini-RCP is used to denote C₂/C₃ random copolymers having low levels of C_{2.} Herein low C₂ levels refer to from about 0.2% to about 0.8% C₂ by weight of the copolymer, alternatively about 0.6% C₂ by weight of the copolymer. Without limitation, examples of suitable C₂/C₃ Mini-RCP include PP 4712E1 Polymer Grade for Oriented Film having about 0.7% ethylene and EOD04-22 POLYPROPYLENE copolymer film grade, which are mini-random copolymers commercially available from ExxonMobil Chemical and Total Petrochemicals USA, Inc. respectively. In an embodiment, the mini-RCP (e.g., EOD04-22) has about the physical properties set forth in Table 4A.

TABLE 4A

| Properties | Typical Value | ASTM Method |
|---|---|---|
| Resin Properties⁽¹⁾ | | |
| Melt Flow, g/10 min. | 3.5 | D 1238 |
| | | Condition “L” |
| Density, g/cc | 0.905 | D 1505 |
| Melting Point, ° F. (° C.) | 313 (156) | DSC⁽²⁾ |
| Film Properties, Oriented⁽¹⁾⁽³⁾ | | |
| Haze, % | 1.5 | D 1003 |
| Gloss, 45°, % | 90 | D 2457 |
| Ultimate Tensile, psi MD (psi TD) | 17,000 (35,000) | D 882 |
| Tensile Modulus, psi MD (psi TD) | 350,000 (600,000) | D 882 |
| Elongation, % MD (TD) | 150 (60) | D 882 |

⁽¹⁾Data developed under laboratory conditions and are not to be used as specification, maxima or minima.
⁽²⁾MP determined with a Differential Scanning Calorimeter.
⁽³⁾Tenter-frame oriented film

In an alternative embodiment, the core layer of a MPF comprises a PP homopolymer (hPP). The pendant methane groups (—CH₃) of the hPP may line up in an isotactic orientation (i.e., on the same side) relative to the backbone of the molecule. An example of a suitable hPP includes without limitation TOTAL POLYPROPYLENE 3371 resin, which is a polypropylene homopolymer commercially available from Total Petrochemicals USA, Inc. In an embodiment, the hPP (e.g., TOTAL POLYPROPYLENE 3371 resin) has about the physical properties set forth in Table 4B.

Table 4B

| Properties | Typical Value | ASTM Method |
|---|---|---|
| Resin Properties⁽¹⁾ | | |
| Melt Flow, g/10 min. | 2.8 | D 1238 |
| | | Condition “L” |
| Density, g/cc | 0.905 | D 1505 |
| Melting Point, ° F. (° C.) | 325 (163) | DSC⁽²⁾ |
| Film Properties, Oriented⁽¹⁾⁽³⁾ | | |
| Haze, % | 1.0 | D 1003 |
| Gloss, 45°, % | 90 | D 2457 |
| Ultimate Tensile, psi MD (psi TD) | 19,000 (38,000) | D 882 |
| Tensile Modulus, psi MD (psi TD) | 350,000 (600,000) | D 882 |
| Elongation, % MD (TD) | 130 (50) | D 882 |
| WVTR, g/100 sq in/24 hrs./mil | 0.3 | F 1249-90 |
| @ 100° F., 90% RH | | |

⁽¹⁾Data developed under laboratory conditions and are not to be used as specification, maxima or minima.
⁽²⁾MP determined with a Differential Scanning Calorimeter.
⁽³⁾Tenter-frame oriented film.

The polymerization of propylene into a random copolymer with an alpha-olefin or a homopolymer may be carried out in the presence of a suitable catalyst and under suitable reaction conditions for polymerization thereof. Such catalysts and conditions are known to one of ordinary skill in the art and are described U.S. Pat. Nos. 4,298,718 and 4,544,717, which have been previously disclosed.

In an embodiment, the inner skin layer, outer skin layer and/or core layer may also comprise additives as deemed necessary to impart the desired physical properties. Examples of additives include without limitation stabilizers, antiblocking agents, slip additives, antistatic agents, ultra-violet screening agents, oxidants, anti-oxidants, ultraviolet light absorbents, fire retardants, processing oils, coloring agents, pigments/dyes, fillers, and/or the like with other components. The aforementioned additives may be used either singularly or in combination to form various formulations of the polymer. For example, stabilizers or stabilization agents may be employed to help protect the polymer resin from degradation due to exposure to excessive temperatures and/or ultraviolet light. These additives may be included in amounts effective to impart the desired properties. Effective additive amounts and processes for inclusion of these additives to polymeric compositions are known to one skilled in the art.

Multilayer film structures and methods for their design are known to one skilled in the art. For example, the MPF may be produced by a coextrusion cast process wherein two or more molten polymers are coextruded through a slot or die to to form a thin, composite extruded sheet (typically having a thickness greater than 10 mils) or film (typically having a thickness equal to or less than 10 mils). The coextruded sheet or film is then adhered to a cooled surface, such as a chill roll that may be in contact with a water bath. The chill roll functions to immediately quench the sheet or film. The sheet or film may then be passed through rollers designed to stretch the sheet in differing axial directions to produce biaxially oriented films, which may be further trimmed and rolled for transport or storage. In an embodiment, the MPF is oriented about 5:1 in the machine direction and from about 7-10:1 in the transverse direction. In an embodiment a polypropylene composition is coextruded into a sheet which is biaxially oriented to form biaxially oriented polypropylene (BOPP) as the MPF.

The extruded film may then be subjected to a surface modification process designed to increase the surface tension of the film, typically on the outer skin layer of the film. Examples of surface modification processes include without limitation corona treatment, flame treatment and plasma treatment. In an embodiment, the MPFs of this disclosure are subjected to corona treatment following a plastics shaping process such as extrusion. Methods and conditions for corona treatment of a MPF are well known to one of ordinary skill in the art. Hereafter, a surface modified MPF refers to a MPF that has been subjected to a surface treatment designed to increase the surface tension of the MPF, for example corona treatment.

A surface-modified MPF of this disclosure may be further processed so as to impart properties as desired by the user. For example, a surface-modified MPF may then be subjected to the process of metallization. The process of metallization involves vacuum deposition of a metal such as aluminum on a surface. In the case of polymeric films, metallization results in films with improved aesthetics and barrier properties. Such metallized films may be further processed, for example printed on the outer skin layer to provide identification and information regarding a packaged product.

In an embodiment, the MPFs of this disclosure may have inner skin layers that function as heat seal layers. Such inner skin layers may display a seal initiation temperature of from about 70° C. to about 125° C., alternatively from about 90° C. to about 120° C. Alternatively, the M of this disclosure may have outer skin layers that function as heat seal layers. Such outer skin layers may display a seal initiation temperature of from about 110° C. to about 130° C., alternatively from about 115° C. to about 120° C. Additionally, the use of a HDPE as an outer skin layer may provide a MPF with improved optical characteristics such as improved clarity when compared to MPFs not having an HDPE outer skin layer.

In an embodiment, the MPF may have a final thickness of from about 0.5 mils to about 2.5 mils, alternatively from about 0.8 mils to about 1.5 mils. MPFs of this disclosure may display enhanced retention of surface tension following a surface modification processes as for example and without limitation corona treatment, flame treatment and/or plasma treatment. In an embodiment, the multilayer polymer film retains an increased surface tension on the surface treated skin layer for greater than about 30, 45, 60, 75, 90, 105, 120, 135, or 150 days in comparison to the surface tension of an otherwise identical film having an untreated outer skin layer. In an embodiment, a surface-modified MPF of this disclosure retains a surface tension of equal to or greater than about 48 dynes/cm for equal to or greater than about 30, 60, or 90 days, alternatively of equal to or greater than about 46 dynes/cm for equal to or greater than about 30, 60, 90, 120, or 150 days, alternatively of equal to or greater than about 44 dynes/cm for equal to or greater than about 30, 60, 90, 120, 150, or 180 days. In an embodiment, a surface-modified, metallized MPF of this disclosure retains a surface tension of equal to or greater than about 48 dynes/cm for equal to or greater than about 30, 60, or 90 days, alternatively of equal to or greater than about 44 dynes/cm for equal to or greater than about 30, 60, 90, or 120, alternatively of equal to or greater than about 40 dynes/cm for equal to or greater than about 30, 60, 90, 120, or 150, alternatively of equal to or greater than about 38 dynes/cm for equal to or greater than about 30, 60, 90, 120, 150, or 180 days.

### EXAMPLES

The invention having been generally described, the following examples are given as particular embodiments of the invention and to demonstrate the practice and advantages thereof. It is understood that the examples are given by way of illustration and are not intended to limit the specification of the claims in any manner.

### Example 1

Oriented MPF structures were prepared in two trials using a commercial, six-meter wide, Bruckner biaxial oriented film line. In both trials the physical and optical properties of a MPF having an A-B-C structure was evaluated. For both trials, the inner skin layer was comprised of ADSYL 5C30F advanced polyolefin which is a terpolymer commercially available from Basell Polyolefins and the core layer comprised TOTAL POLYPROPYLENE 3371 resin which is a polypropylene homopolymer commercially available from Total Petrochemicals USA, Inc. In Trial 1, the outer skin layer comprised 6450 HDPE which is a polyethylene resin commercially available from Total Petrochemicals USA, Inc. while for Trial 2 the outer skin layer comprised ADSYL 3C30F advanced polyolefin which is a ethylene-propylene-butene-1 random terpolymer commercially available from Basell Polyolefins. The successful evaluation of the films produced in each trial required satellite extruder temperature profile and die temperature adjustments in order to process, the film (see Table 5) while all other parameters remained the same. Some curling of the film ( 1/2 in) at the edges was also observed, which is not unexpected for an asymmetric film structure. However, due to insufficient material (200 lbs) it was not possible to correct this effect. All films were run at the typical film production speed of 150 m/min. Machine direction orientation was 4.8:1; transverse direction was 8.8:1.

TABLE 5

| | Trial 1 | Trial 2 |
|---|---|---|
| Skin layer, | Basell Adsyl 5C30F | Basell Adsyl 5C30F |
| non-treated side | | |
| (interior) | | |
| Core layer | Total Petrochemicals | Total Petrochemicals |
| | 3371 polypropylene | 3371 polypropylene |
| Skin layer, | Total Petrochemicals | Basell Adsyl 3C30F |
| treated side (exterior) | 6450 polyethylene | terpolymer |
| Line speed | 150 m/min | 150 m/min |
| Machine Direction | 4.8 | 4.8 |
| (MD) ratio | | |
| Transverse Direction | 8.8 | 8.8 |
| (TD) ratio | | |
| Film thickness | 30 microns | 30 microns |
| Water bath temperature, | 20 | 20 |
| ° C. | | |
| Cast roll temperature, | 23 | 23 |
| ° C. | | |
| Satellite Extruder | 265 | 240 |
| (Exterior) ,° C. | | |
| Die, ° C. | 240 | 220 |
| MD preheating | 120 | 120 |
| temperature, ° C. | | |
| MD stretching | 115 | 115 |
| temperature, ° C. | | |
| MD annealing | 115 | 115 |
| temperature, ° C. | | |
| TD preheating | 168 | 168 |
| temperature, ° C. | | |
| TD stretching | 155 | 155 |
| temperature, ° C. | | |
| TD annealing | 160 | 160 |
| temperature, ° C. | | |

Standard optical, seal initiation temperature (SIT) and dimension stability tests were conducted on the film samples produced in Trials 1 and 2 (see Table 6).

TABLE 6

| Skin layer | 6450 | 3C30F |
|---|---|---|
| Haze, % | 1.4 | 1.8 |
| Gloss @ 45° | 91 | 90 |
| SIT Ext. (° C.) | 120 | 114 |
| Dimension stability @ 135° C. (liquid bath, 10 sec) | | |
| MD % | 3 | 3 |
| TD % | 1.5 | 1.5 |

No remarkable differences were observed in optical properties. As expected a higher SIT (120° C.) was observed using 6450 HDPE polyethylene resin as a skin layer versus the ADSYL 3C30F advanced polyolefin (114° C.). No differences in film dimension stability (shrinkage) were observed.

### Example 2

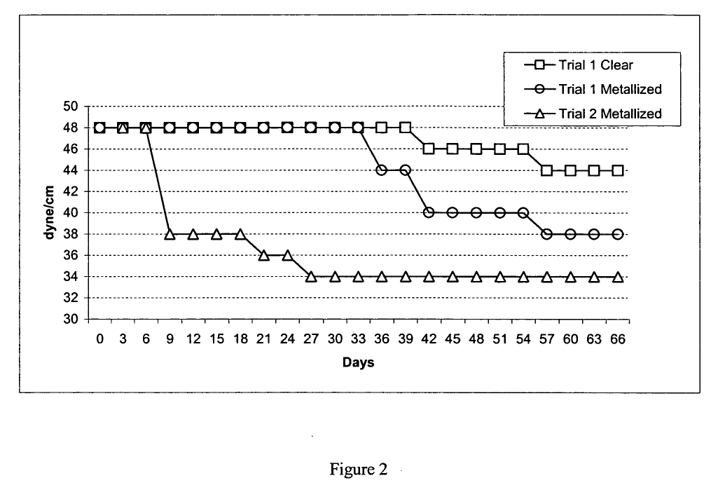

The performance of a HDPE as a skin layer to improve surface treatment retention was evaluated. The films prepared in Example 1, Trials 1 and 2 were corona treated and metallized, and the surface tension of the MPFs measured over a sixty-six day period. As a comparison, a film prepared as described in Trial 1 and corona treated but not metallized, denoted in FIG. 2 as Trial 1 Clear, was also evaluated for surface treatment retention. The MPF surface tension was determined in accordance with ASTM D 2578-99 Standard test method for wetting tension of polyethylene and polypropylene films. Briefly, the method involves using a series of mixed liquids (inks) with increasing surface tensions (measured in dynes/cm) that are applied to a treated surface until a liquid is found that just wets the surface. The surface tension of the plastic is then approximated to be equal to the surface tension of the liquid that just wets the surface. FIG. 2 is a graph of the surface tension as a function of time for the MPFs produced in Trials 1 and 2. The test is carried out at 40° C. and 50% relative humidity (RH), which promotes accelerated aging of the polymeric film. Under the conditions of this test, it was estimated that one test day was equivalent to three days of real world exposure at room temperature with 25% humidity. The results demonstrate significantly increased retention of corona treatment (surface tension) for Trial 1 films produced with Total Petrochemicals 6450 HDPE polyethylene resin versus the standard terpolymers of Trial 2.

While preferred embodiments of the invention have been shown and described, modifications thereof can be made by one skilled in the art without departing from the spirit and teachings of the invention. The embodiments described herein are exemplary only, and are not intended to be limiting. Many variations and modifications of the invention disclosed herein are possible and are within the scope of the invention. Where numerical ranges or limitations are expressly stated, such express ranges or limitations should be understood to include iterative ranges or limitations of like magnitude falling within the expressly stated ranges or limitations (e.g., from about 1 to about 10 includes, 2, 3, 4, etc.; greater than 0.10 includes 0.11, 0.12, 0.13, etc.). Use of the term “optionally” with respect to any element of a claim is intended to mean that the subject element is required, or alternatively, is not required. Both alternatives are intended to be within the scope of the claim. Use of broader terms such as comprises, includes, having, etc. should be understood to provide support for narrower terms such as consisting of, consisting essentially of, comprised substantially of, etc.

Accordingly, the scope of protection is not limited by the description set out above but is only limited by the claims which follow, that scope including all equivalents of the subject matter of the claims. Each and every claim is incorporated into the specification as an embodiment of the present invention. Thus, the claims are a further description and are an addition to the preferred embodiments of the present invention. The discussion of a reference herein is not an admission that it is prior art to the present invention, especially any reference that may have a publication date after the priority date of this application. The disclosures of all patents, patent applications, and publications cited herein are hereby incorporated by reference, to the extent that they provide exemplary, procedural or other details supplementary to those set forth herein.

What is claimed is:

1. A multilayer polymer film having at least one core layer disposed between an outer skin layer and an inner skin layer wherein the outer skin layer is surface treated and comprises a polymer of ethylene having a density of at least 0.95 g/cc, a molecular weight distribution of less than about 7.0 and a Carreau-Yasuda “a” parameter value of greater than about 0.25.

2. The film of claim 1 wherein the outer skin layer is corona treated, flame treated, plasma treated, or combinations thereof.

3. The film of claim 2 wherein the surface treated outer skin layer is metallized.

4. The film of claim 1 wherein the multilayer polymer film retains an increased surface tension on the surface treated skin layer for greater than about 30 days in comparison to the surface tension of an otherwise identical film having an untreated outer skin layer.

5. The method of claim 1 wherein the multilayer polymer film has a surface tension of equal to or greater than about 48 dynes/cm for equal to or greater than about 30 days.

6. The method of claim 1 wherein the multilayer polymer film structure has a surface tension of equal to or greater than about 46 dynes/cm for equal to or greater than about 90 days.

7. The method of claim 1 wherein the multilayer polymer film structure has a surface tension of equal to or greater than about 40 dynes/cm for equal to or greater than about 120 days.

8. The film of claim 1 wherein the polymer of ethylene in the outer skin layer is metallocene catalyzed.

9. The film of claim 1 wherein the inner skin layer comprises an ethylene-based terpolymer, a propylene-based terpolymer, a random copolymer, or combinations thereof.

10. The film of claim 1 wherein the core layer comprises a propylene-ethylene random copolymer, a propylene-ethylene mini-random copolymer, a propylene homopolymer, or combinations thereof.

11. The film of claim 1 wherein the film is a cast film.

12. The film of claim 1 wherein the film is biaxially oriented.

13. The film of claim 1 wherein the inner skin layer is a heat seal layer.

14. The film of claim 1 wherein the film has a thickness of from about 0.5 mils to about 2.5 mils.

15. A multilayer polymer film having at least one core layer disposed between a high density polyethylene outer skin layer and an inner skin layer wherein the outer skin layer is surface treated and retains an increased surface tension on the surface treated skin layer for greater than about 30 days in comparison to the surface tension of an otherwise identical film having an untreated outer skin layer.

16. The film of claim 15 wherein the outer skin layer is corona treated.

17. The film of claim 16 wherein the outer skin layer is metallized.

18. A surface treated, outer skin layer of a multilayer polymer film, wherein the outer skin layer comprises high density polyethylene and retains an increased surface tension on the surface treated skin layer for greater than about 30 days in comparison to the surface tension of an otherwise identical film having an untreated outer skin layer.

19. The outer skin of layer of claim 18 wherein the outer skin layer is corona treated.

20. The outer skin layer of claim 19 wherein the outer skin layer is metallized.
